(19) United States
(12) Patent Application Publication
(10) Pub. No.: US 2007/0217213 A1
(43) Pub. Date: Sep. 20, 2007

(54) Direction lamp of a vehicle

(76) Inventor: Yuan-Tai Chang, Hsinchu Hsien (TW)

Correspondence Address: YUAN-TAI CHANG, Box 8-24, 235 Chung - Ho, Taipei, omitted

(21) Appl. No.: 11/507,276

(22) Filed: Aug. 22, 2006

(30) Foreign Application Priority Data
Mar. 17, 2006 (TW) 95109149

(51) Int. Cl. B60Q 1/26

(52) U.S. Cl. 362/503; 362/498

(57) ABSTRACT

A direction lamp of a vehicle is disclosed. A direction lamp is embedded in a rear windshield of a vehicle body. The direction lamp being formed with a plurality of recesses; a plurality of LED lamps being embedded into the recesses. The LED lamps are connected to the direction lamp through a printed circuit. The direction lamp is connected to a brake lamp. The direction lamp is arranged as an arrow or characters, such as a word of right or left.

### FIELD OF THE INVENTION

The present invention relates to vehicle direction lamps, and in particular to a direction lamp of a vehicle which is installed to a rear windshield for alerting other drivers.

### BACKGROUND OF THE INVENTION

Conventionally, direction lamps are installed at a backside of a vehicle for alerting other drivers to keep attention to the action of the former cars. Generally, the direction lamp is tungsten lamps which are unstable and power consumed. Thereby the lifetime of tungsten lamp is short.

To improve the defects in the prior art, LED lamps are used as direction lamps, which have long lifetime and power saved. However the use of LED lamp cannot reduce the possibility of accident. This is because the prior art LED lamps have only one power source and are installed at a lower portion of the backside of a vehicle so that it cannot effectively alert other drivers to keep attention the action of the former cars.

Thus, some improvements are provided, in that the direction lamps are installed at different locations of a vehicle so as to make other drivers have more attentions to the direction lamps. However by our experience, these improvement still has no apparent effect.

### SUMMARY OF THE INVENTION

Accordingly, the primary object of the present invention is to provide a direction lamp of a vehicle, wherein the direction lamp is located on the rear windshield so that other drivers can view the indication of the direction lamp clearly to reduce the danger in driving. Furthermore, the direction lamp is embedded into the rear windshield. It provides a beautiful outlook and the direction lamp can be retained firmly without falling out.

To achieve above objects, the present invention provides a direction lamp of a vehicle. A direction lamp is embedded in a rear windshield of a vehicle body. The direction lamp is formed with a plurality of recesses; and a plurality of LED lamps are embedded into the recesses. The LED lamps are connected to the direction lamp through a printed circuit. The direction lamp is connected to a brake lamp. The direction lamp is arranged as an arrow or characters, such as a word of right or left.

The various objects and advantages of the present invention will be more readily understood from the following detailed description when read in conjunction with the appended drawing.

### BRIEF DESCRIPTION OF THE DRAWINGS

FIG. 1 is a perspective view about the direction lamp of a vehicle body of the present invention.

FIG. 2 is a schematic perspective view about the direction lamp of a vehicle body of the present invention.

FIG. 2A is a partial enlarged view showing that the present invention is applied to a rear windshield.

FIG. 3 shows an application of the present invention, where the present invention is connected with brake lamps of a vehicle.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

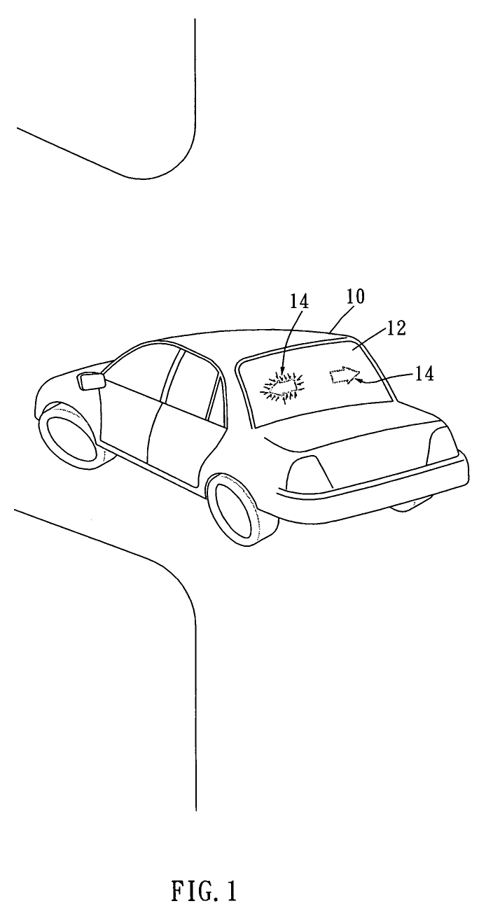

Referring to FIG. 1, the direction indicator of a vehicle is illustrated. The present invention is mainly installed to the windshields of a vehicle. However in the following, the rear windshields 12 are used as an example. The present invention has the following elements.

The direction lamp 14 on the rear windshield 12 of a vehicle body 10 is realized by two ways.

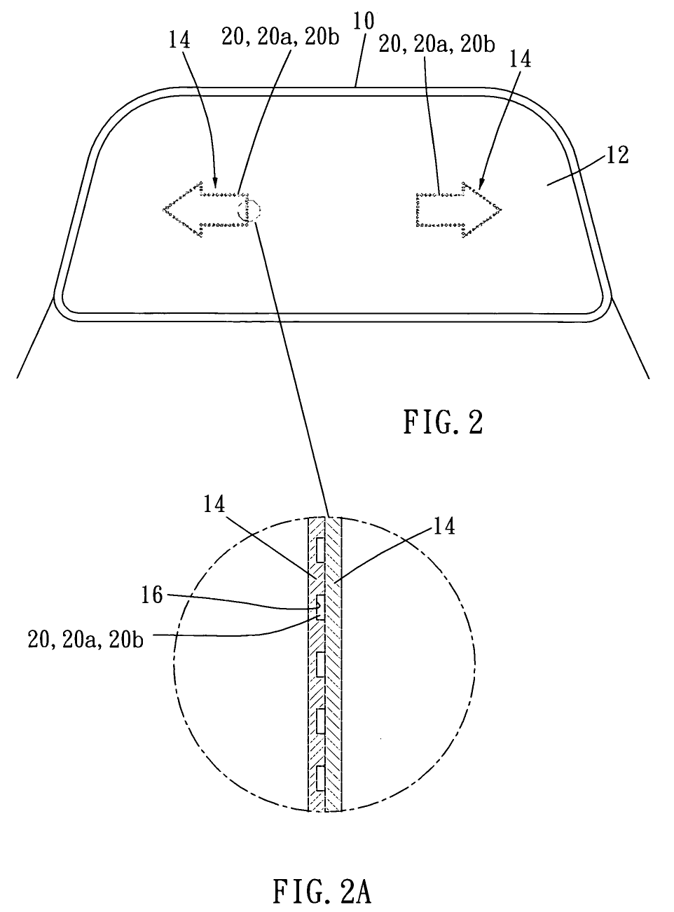

In FIGS. 2 and 2A, a direction lamp 14 is embedded in a rear windshield 12 of a vehicle body 10. The direction lamp 14 is formed with a plurality of recesses 16. A plurality of LED lamps 20 are embedded into the recesses 16. The LED lamps 20 are connected to the direction lamp 14 through a printed circuit (not shown). The direction lamp 14 can be formed as two arrows, as illustrated in the drawing. The LED lamps 20 may be replaced by OLED lamps. Furthermore, the LED lamps 20 may be arranged as words of “right” or “left”, which may be Chinese characters.

The present invention is a novel design which can capture the attentions of other drivers. Thereby the direction lamp 14 can be presented as word of left or right so as to cover a larger area to capture the attention of other users and thus the possibility of occurring accident is lowered.

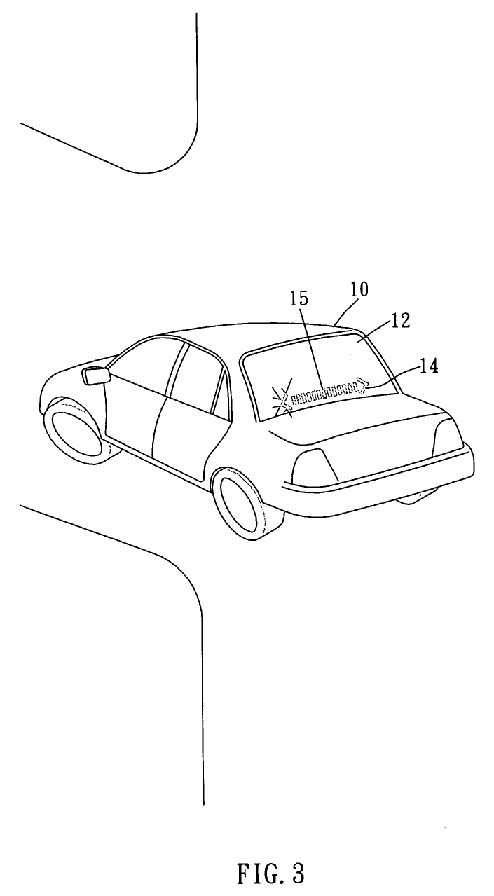

Referring to FIG. 3, in the present invention, the direction lamp 14 may be connected to a brake lamp 15 to provide the information of braking.

To reduce the thickness of the rear windshield 12, in the present invention, the thin LED lamps 20, OLED lamps 20a (Organic Light Emitting Diode), or EL20b (Electro Luminescent) can be used. Thereby different colors of LED lamps 20 can be used for providing some different configurations to users.

Advantages of the present invention will be described herein. The direction lamp is located on the rear windshield so that other drivers can view the indication of the direction lamp clearly to reduce the danger in driving. Furthermore, the direction lamp is embedded into the rear windshield. It provides a beautiful outlook and the direction lamp can be retained firmly without falling out.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A direction lamp of a vehicle; wherein a direction lamp is embedded in a rear windshield of a vehicle body; the direction lamp being formed with a plurality of recesses; a plurality of LED lamps being embedded into the recesses; the LED lamps being connected to the direction lamp through a printed circuit.

2. The drilling-head-grinding positioning device as claimed in claim 1, wherein the LED lamps are OLED lamps.

3. The direction lamp of a vehicle as claimed in claim 1, wherein The LED lamps are electron luminous lamps.

4. The direction lamp of a vehicle as claimed in claim 1, wherein direction lamp is arranged at two sides of the rear windshield.

5. The direction lamp of a vehicle as claimed in claim 1, wherein the direction lamp is connected to a brake lamp.

6. The direction lamp of a vehicle as claimed in claim 1, wherein the direction lamp is arranged as an arrow.

7. The direction lamp of a vehicle as claimed in claim 1, wherein the direction lamp is arranged as characters.

8. The direction lamp of a vehicle as claimed in claim 1, wherein the direction lamp is arranged as a word of “right”.

9. The direction lamp of a vehicle as claimed in claim 1, wherein the direction lamp is arranged as a word of “left”.

10. The direction lamp of a vehicle as claimed in claim 1, wherein the direction lamp is arranged as a Chinese character which means “right”.

11. The direction lamp of a vehicle as claimed in claim 1, wherein the direction lamp is arranged as a Chinese character which means “left”.

12. The direction lamp of a vehicle as claimed in claim 1, wherein the LED lamps have different colors and different flash ways.
